(19) United States
(12) Patent Application Publication
(10) Pub. No.: US 2018/0264412 A1
(43) Pub. Date: Sep. 20, 2018

(54) Fluid separation membrane module assembly

(71) Applicants: FUJIFILM MANUFACTURING EUROPE B.V., Tilburg (NL); FUJIFILM CORPORATION, Tokyo (JP)

(72) Inventors: Erwin Michael Toet, Tilburg (NL); Yujiro Itami, Tilburg (NL); Adrianus Johannes Antonius van Geffen, Tilburg (NL); Misha Dennis, Tokyo (JP)

(73) Assignees: FUJIFILM MANUFACTURING EUROPE B.V., Tilburg (NL); FUJIFILM CORPORATION, Tokyo (JP)

(21) Appl. No.: 15/762,570

(22) PCT Filed: Sep. 15, 2016
(86) PCT No.: PCT/EP2016/071876

§ 371 Date: Mar. 23, 2018

(30) Foreign Application Priority Data
Sep. 24, 2015 (GB) 1516909.7

(51) Int. Cl. B01D 63/12; B01D 53/22; C10L 3/10

(52) U.S. Cl. CPC B01D 63/12; B01D 53/226; B01D 53/227; C10L 3/104; C10L 2290/548; B01D 2313/08; B01D 2317/02; B01D 2317/04; B01D 2313/54

(57) ABSTRACT

Fluid separation membrane module assembly with a vessel (7) having a tubular shape with a tubular surface and two opposite end apertures and one or more fluid separation membrane modules (12) positioned along a centerline of the vessel (7). Each fluid separation membrane module (12) comprises membrane elements configured for separating a feed flow into a residual flow and a permeate flow. Adjacent ones of the one or more fluid separation membrane modules (12) are fluidly connected together. The fluid separation membrane module assembly further comprises a feed and permeate connection assembly (6) closing off one of the two opposite end apertures of the vessel (7). The feed and permeate connection assembly (6) has a feed connector (5) and a permeate connector (3). The feed connector (5) and the permeate connector (3) are positioned off-center in the feed and permeate connection assembly (6).

### FIELD OF THE INVENTION

The present invention relates to a fluid separation membrane module assembly, comprising a vessel having a tubular shape with a tubular surface and two opposite end apertures, one or more fluid separation membrane modules positioned along a centerline of the vessel, wherein each fluid separation membrane module comprises membrane elements configured for separating a feed flow into a residual flow and a permeate flow, and wherein adjacent ones of the one or more fluid separation membrane modules are fluidly connected together.

### PRIOR ART

US patent publication US2013/0206672 discloses membrane separation assemblies for fluid separation having multiple membrane modules coupled to each other in a directly coupled arrangement inside a vessel. Multiple vessels can be positioned in a parallel array configuration using a main feed flow as well as a main permeate flow and main retentate flow. The (high pressure) feed flow is connected to each vessel using a side connection, allowing to have a central retentate flow in each vessel.

International patent publication WO2012/036942 discloses a filtration apparatus having a plurality of membrane modules arranged in series in a housing/chamber. The apparatus further comprises an inlet port at a first end of the housing and an outlet port at a second end of the housing spaced apart from the first end. Also, a permeate collection conduit is provided connected to a first permeate outlet that extends out of an end wall at the first end of the housing.

US patent publication US2007/272628 discloses an apparatus for treating a solution of high osmotic strength. The apparatus comprises a pressure vessel having ports on opposite ends for passing feed solution into the vessel and removing the concentrate solution. Feed solution flows from the lead element at the inlet end of the vessel, across intermediate elements, to the tail element at the opposite outlet end of the vessel. Interconnectors are used to connect permeate tubes of adjacent elements, and the combined permeate is removed from at least one permeate port in the vessel.

US patent publication U.S. Pat. No. 4,874,405 discloses a tubular separation module having a plurality of membrane elements, a feed gas inlet port, a residual output port and a permeate outlet port arranged at opposing end plates of the module.

### SUMMARY OF THE INVENTION

The present invention seeks to provide an improved operation and construction of a fluid separation installation.

According to the present invention, a fluid separation membrane module as defined above is provided, wherein the fluid separation membrane module assembly further comprises a feed and permeate connection assembly closing off one of the two opposite end apertures of the vessel, the feed and permeate connection assembly comprising a feed connector and a permeate connector. The feed connector and the permeate connector are positioned off-center in the feed and permeate connection assembly. This structure allows to have no side input into the vessel, and therefore, a vessel of lesser strength can be used (e.g. having a reduced wall thickness, other material, etc.). Furthermore, the present invention embodiments provide the opportunity to optimize the flow to and from the fluid separation membrane modules.

The feed and permeate connection assembly may comprise a bayonet coupling to the end part of the vessel to allow easy assembly (and disassembly when needed) of the fluid separation membrane module assembly.

In further embodiments, a feed deflector assembly is provided downstream from the feed connector and upstream from a first one of the one or more fluid separation membrane modules. The feed deflector assembly may comprise one or more perforated plates positioned perpendicular to the centerline of the vessel. This allows to obtain a uniform feed flow to the first one of the one or more fluid separation membrane modules.

Furthermore, a permeate deflector assembly may be provided downstream from the first one of the one or more fluid separation modules and upstream from the permeate connector. The permeate deflector assembly e.g. comprises a curved permeate pipe to guide the permeate flow from the centerline of the fluid separation membrane modules to the off-centered permeate connector. The one or more perforated plates have a central aperture in a further embodiment accommodating the permeate deflector assembly.

In a further aspect, the present invention relates to a fluid separation installation comprising a plurality of fluid separation membrane module assemblies according to the present invention embodiments. The plurality of fluid separation membrane module assemblies may be stacked, and because of all external connections being at the end parts of each vessel, a mutual spacing can be used which is lower than that of prior art installations having a side feed to the vessels. A main feed pipe may be provided in fluid communication with the feed connectors of each of the plurality of fluid separation membrane module assemblies, allowing a compact build of the installation. Similarly, a permeate collection pipe may be provided in fluid communication with the permeate connectors of each of the plurality of fluid separation membrane module assemblies.

### SHORT DESCRIPTION OF DRAWINGS

The present invention will be discussed in more detail below, using a number of exemplary embodiments, with reference to the attached drawings, in which

FIG. 1 shows a perspective view of a part of a fluid separation installation according to an embodiment of the present invention; and

FIG. 2 shows a cross sectional view of a front part of a fluid separation membrane module assembly according to an embodiment of the present invention.

### DETAILED DESCRIPTION OF EXEMPLARY EMBODIMENTS

The present invention relates to fluid separation in general, and more particular to gas separation, e.g. separating a CO₂ fraction from a natural gas (CH₄) feed flow. For the separation process, use can be made of fluid separation membrane modules arranged in a fluid separation installation.

The details of the fluid separation membrane modules are known as such to the person skilled in the art, and are e.g. described in the US patent publication US2013/0206672 which is incorporated herein by reference in its entirety. In general, fluid separation membrane modules are positioned along a centerline of a (pressure) vessel, wherein each fluid separation membrane module comprises membrane elements configured for separating a feed flow into a residual flow and a permeate flow. The membrane elements are e.g. spirally wound membrane sheets kept apart using a spacer element, allowing to obtain a very high surface area of the membrane element being exposed to the feed flow. The feed flow and permeate flow are then cross flows on each side of a membrane. The permeate flow can e.g. be collected in a centrally located collection pipe provided with suitable apertures towards the membrane elements. The feed flow and residual flow are usually at high pressure, whereas the permeate flow is at a (much) lower pressure.

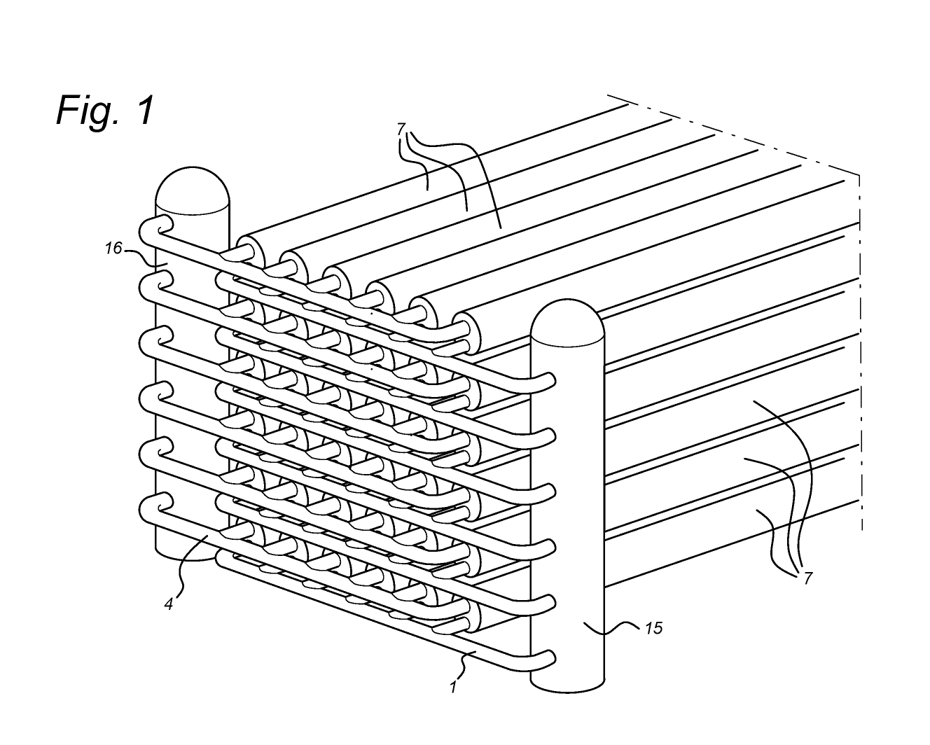

FIG. 1 shows a perspective view of a part of a fluid separation installation according to an embodiment of the present invention. A number of fluid separation membrane module assemblies (of which the (pressure) vessels 7 are visible) are positioned in an array configuration to form the fluid separation installation. From a main feed pipe 16, a feed flow is distributed towards each of the vessels 7 using multiple feed distribution pipes 4. On the same side of the fluid separation installation, permeate output pipes 1 obtain the permeate flow from each vessel 7, and the permeate flow is collected into a permeate collection pipe 15. It is noted, that on the other side of the fluid separation installation, similar arrangements are present for collection of the residual flow (or retentate flow).

The entire fluid separation installation can be mounted on a skid or the like, allowing for easy transport to and installation on a remote location where these fluid separation installation are employed.

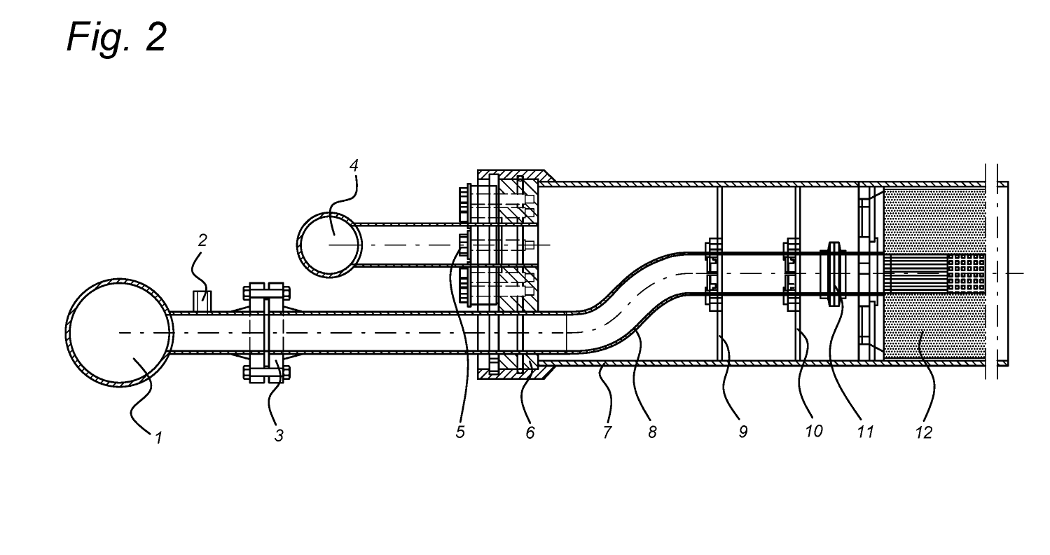

FIG. 2 shows a cross sectional view of a front part of a fluid separation membrane module assembly according to an embodiment of the present invention. The main element of the fluid separation membrane module is a vessel 7, which forms a housing for a number of fluid separation membrane modules 12. Multiple fluid separation membrane modules 12 can be fluidly connected in series, using coupling elements to connect to each other inside the vessel 7. In the embodiment shown, the fluid separation membrane modules 12 are of the wound and cross flow type, as a result of which the coupling elements can be relatively simple couplings of the centrally located permeate collection pipes (as it is a relatively low pressure) of adjacent ones of the fluid separation modules 12. The wall of the vessel 7 then fluidly connects the feed flow/residual flow of adjacent ones of the fluid separation modules 12 (from left to right in FIG. 2).

The vessel 7 in the embodiments of the present invention has a straight, tubular shape with a tubular surface and two opposite end apertures. One of the end apertures is closed off by a feed and permeate connection assembly 6, e.g. as shown in the form of a lid of the pressure vessel 7. The feed and permeate connection assembly 6 comprises a feed connector 5, e.g. in the form of a feed connection flange as part of the lid cooperating with appropriate (high pressure) sealing elements. Furthermore, the feed and permeate connection assembly 6 comprises a permeate connector 3. In the embodiment shown, the permeate connector 3 is formed by a pipe welded (sealed) in the lid.

As both the feed connection and the permeate connection are provided in an end aperture of the vessel 7, the design parameters of the vessel can be less stringent then when using side connectors to a pipe, as in prior art fluid separation installations. E.g. a reduced wall thickness of the vessel 7 can be implemented, or other less costly material may be used. Furthermore, the vessels 7 of a fluid separation installation can be mounted closer to each other, as all the flows are connected to the end apertures of each vessel 7. It is noted that at the other side of the vessel 7, output of the residual flow may be implemented using a residual flow output connection assembly (not shown) closing off the other end aperture of the vessel (no side output from vessel). The fluid separation installation can thus be of a more compact construction for a same amount of capacity.

As shown in the embodiment of FIG. 2, the feed connector 5 and the permeate connector 3 are positioned off-centre in the feed and permeate connection assembly. One of the feed connector 5 and permeate connector 3 could be arranged at the centerline of the vessel 7, however in view of optimization of cross section of the vessel 7 (in view of the diameters of the feed connector 5 and permeate connector 3) an embodiment where both are positioned off-centre is advantageous to optimize the flows to and from the fluid separation membrane modules 12.

In the embodiment shown, the feed and permeate connection assembly 6 comprises a bayonet coupling to the end part of the vessel 7. Using proper sealing elements, this may provide a cost-efficient implementation to close off that end of the vessel 7 (as opposed to a bolted coupling which needs a lot of bolts around the perimeter of the end part of the vessel 7). The feed connector 5 may be provided with a coupling arrangement allowing to use high pressure, such as a separate sealing element and a bolted flange arrangement.

As the connections to the vessel 7 for the feed flow and permeate flow are off centered in the feed and permeate connection assembly 6, further elements are provided in further embodiments of the present invention.

A feed deflector assembly is provided downstream from the feed connector 5 and upstream from a first one of the one or more fluid separation membrane modules 12. In the embodiment shown in FIG. 2, the feed deflector assembly comprises one or more perforated plates 9, 10 positioned perpendicular to the centerline of the vessel 7, which will cause a uniform feed flow to the feed flow input of the first fluid separation membrane module 12.

The design parameters of the one or more perforated plates 9, 10 (pattern, amount of holes, diameter hole, distance between the one or more perforated plates 9, 10, amount of perforated plates 9, 10 used) may be optimized based on the specific feed flow and gas mixtures composition and its pressure. In case the process is the separation of a feed gas CO₂ and CH₄ into a gas mixture enriched in CO₂ and a gas mixture depleted in CO₂ the feed usually comprises 15 to 90 mol % of CO₂ with inlet pressures ranging between 10 to 150 bar at a temperature between 20 and 60° C.

Further the feed flow rates at the entrance are advantageously in the range of 0.5-2.0 MMSCFD (million standard cubic feet of gas flow per day).

The perforated plate 9, 10 may take any shape, e.g. flat, hemispherical, conical etc. but advantageously it is flat (as shown in the embodiment of FIG. 2, which form is easy to manufacture and to handle).

As shown in the embodiment of FIG. 2, the perforated plates 9, 10 are oriented in a plane which is substantially parallel to the closest of the two end faces of the module.

The feed deflector assembly of the present invention embodiments causes the gas pressure on the inlet side of the nearest end face of the vessel 7 to vary by no more than 25% across the entire surface area of that end face (i.e. at the feed and permeate connection assembly 6).

The cross-sectional area of the perforated plates 9, 10, including the area of the perforations, is e.g. at least 75% (e.g. at least 85%, especially at least 95%) of the area of the end face of the vessel 7 closest to the perforated plate 9, 10 (including the central area of the end face occupied by the permeate deflector assembly 8, see below for further details). In one embodiment of the invention only one perforated plate 9, 10 is used. In another embodiment a plurality of perforated plates 9, 10 is used as shown in FIG. 2 where two perforated plates 9, 10 are used.

The feed deflector assembly may be made from any suitable material, for example from a ceramic, glass or plastics material or more preferably from a metal (e.g. stainless steel). The gas velocity and pressure entering the vessel 7 can be high, therefore a material will be selected which can withstand the conditions to be encountered by the feed deflector assembly.

In an exemplary embodiment, the perforated plate 9, 10 has a thickness of at least 1 mm, e.g. 1 to 5 mm or even more than 5 mm. The number of perforations in the perforated plate 9, 10 is e.g. more than 50, e.g. more than 100, especially more than 200. There is no particular upper limit, although typically less than 1,000 perforations will be used. The perforations allow feed gas entering the vessel 7 to contact the fluid separation membrane module 12 and can be used to slow the feed gas and even-out the gas pressures being exerted onto the fluid separation membrane module 12. The number of perforations chosen will depend to some extent on the size of the perforations. For example, it is advantageous not to impede the flow of gas too much, therefore if the perforations are small generally more perforations will be provided than when the perforations are larger. It will be apparent to the person skilled in the art that the perforations do not need to be all of the same size or shape. The shape of the perforations is not crucial, for example they may be round, diamond, heliarc, square shaped or otherwise shaped or even a be combination of more than one shape.

The perforated plates 9, 10 may comprise a uniform distribution of perforations, as this helps to provide a uniform gas pressure on the first fluid separation membrane module 12. When a non-uniform distribution of perforations is used, the % perforations per cm² advantageously does not vary by more than 25% across the surface of the perforated plate 9, 10. The perforated plate 9, 10 e.g. has a % perforation of 0.5 to 30%, such as 2 to 25% or more specifically 5 to 20%

The permeate connector 3 is positioned off-center, and a permeate deflector assembly 8 is provided, in a further embodiment, downstream from the first one of the one or more fluid separation modules 12 and upstream from the permeate connector 3. In the embodiment shown in FIG. 2 the permeate deflector assembly 8 comprises a curved permeate pipe 8 connecting to the centrally located permeate flow connection of the fluid separation membrane module 12. To allow easy and cost-efficient assembly, the one or more perforated plates 9, 10 of the embodiment of FIG. 2 have a central aperture accommodating the permeate deflector assembly 8. The perforated plates 9, 10 and permeate deflector assembly 8 are connected to each other using appropriate fixing elements, in order to maintain a proper (counter)flow of both the feed flow and the permeate flow. Furthermore, for checking proper operation, the part of the permeate connector 3 external to the vessel 7 (or the permeate output pipes 1) may be provided with a sampling port 2.

As described above in relation to FIG. 1, the present invention also relates to a fluid separation installation comprising a plurality of fluid separation membrane module assemblies according to any one of the embodiments described above. This allows a more compact construction of an entire fluid separation installation, and also a more cost-effective solution than prior art installations. E.g. the plurality of fluid separation membrane module assemblies are stacked in an embodiment, as the one shown in FIG. 1, allowing a mutual spacing lower than that of prior art installation using a side feed to each vessel.

As shown in the embodiment of FIG. 1, the fluid separation installation comprises a main feed pipe 16 in fluid communication with the feed connectors 5 of each of the plurality of fluid separation membrane assemblies, e.g. using the feed distribution pipes 4. Furthermore, a permeate collection pipe 15 is provided in a further embodiment, which is in fluid communication with the permeate connector 3 of each of the plurality of fluid separation membrane assemblies.

The present invention embodiments have been described above with reference to a number of exemplary embodiments as shown in the drawings. Modifications and alternative implementations of some parts or elements are possible, and are included in the scope of protection as defined in the appended claims.

1. A fluid separation membrane module assembly, comprising a vessel having a tubular shape with a tubular surface and two opposite end apertures, one or more fluid separation membrane modules positioned along a centerline of the vessel, wherein each fluid separation membrane module comprises membrane elements configured for separating a feed flow into a residual flow and a permeate flow, and wherein adjacent ones of the one or more fluid separation membrane modules are fluidly connected together, wherein the fluid separation membrane module assembly further comprises a feed and permeate connection assembly closing off one of the two opposite end apertures of the vessel, the feed and permeate connection assembly comprising a feed connector and a permeate connector, wherein the feed connector and the permeate connector are positioned off-center in the feed and permeate connection assembly.

2. The fluid separation membrane module assembly according to claim 1, wherein the feed and permeate connection assembly comprises a bayonet coupling to the end part of the vessel.

3. The fluid separation membrane module assembly according to claim 1, further comprising a feed deflector assembly downstream from the feed connector and upstream from a first one of the one or more fluid separation membrane modules.

4. The fluid separation membrane module assembly according to claim 3, wherein the feed deflector assembly comprises one or more perforated plates positioned perpendicular to the centerline of the vessel.

5. The fluid separation membrane module assembly according to claim 1, further comprising a permeate deflector assembly downstream from the first one of the one or more fluid separation modules and upstream from the permeate connector.

6. The fluid separation membrane module assembly according to claim 5, wherein the permeate deflector assembly comprises a curved permeate pipe.

7. The fluid separation membrane module assembly according to claim 4 and further comprising a permeate deflector assembly downstream from the first one of the one or more fluid separation modules and upstream from the permeate connector, wherein the one or more perforated plates have a central aperture accommodating the permeate deflector assembly.

8. The fluid separation installation comprising a plurality of fluid separation membrane module assemblies according to claim 1.

9. The fluid separation installation according to claim 8, wherein the plurality of fluid separation membrane module assemblies are stacked.

10. The fluid separation installation according to claim 8, comprising a main feed pipe in fluid communication with the feed connectors of each of the plurality of fluid separation membrane module assemblies.

11. The fluid separation installation according to claim 8, comprising a permeate collection pipe in fluid communication with the permeate connectors of each of the plurality of fluid separation membrane module assemblies.
